(19) United States
(12) Patent Application Publication
(10) Pub. No.: US 2025/0310144 A1
(43) Pub. Date: Oct. 2, 2025

(54) MULTICAST-BROADCAST SERVICES IN NON-TERRESTRIAL NETWORKS

(71) Applicant: Apple Inc., Cupertino, CA (US)

(72) Inventors: Fangli Xu, Beijing (CN); Chunhai Yao, Beijing (CN); Chunxuan Ye, San Diego, CA (US); Dawei Zhang, Saratoga, CA (US); Haijing Hu, Los Gatos, CA (US); Jie Cui, San Jose, CA (US); Yuqin Chen, Beijing (CN)

(21) Appl. No.: 19/097,091

(22) Filed: Apr. 1, 2025

Related U.S. Application Data
(60) Provisional application No. 63/572,557, filed on Apr. 1, 2024.

(51) Int. Cl. H04L 12/18

(52) U.S. Cl. CPC H04L 12/1845

(57) ABSTRACT

The disclosure provides methods, systems, apparatuses, and computer programs for Multicast-Broadcast Services (MBS) in a Non-Terrestrial Networks (NTN) network. The methods include: receiving an information element (IE) including Multicast-Broadcast Services (MBS) service area information indicating one or more MBS service areas in a non-terrestrial network (NTN) serving cell.

### CROSS REFERENCE TO RELATED APPLICATION

This application claims the priority and benefit of U.S. Provisional Patent Application No. 63/572,557, filed Apr. 1, 2024, entitled “MULTICAST-BROADCAST SERVICES IN NON-TERRESTRIAL NETWORKS,” which is incorporated by reference.

### BACKGROUND

Wireless communication networks, such as the Third Generation Partnership Project (3GPP) Fourth Generation (4G), Fifth Generation (5G) networks, among others, provide integrated communication platforms and telecommunication services to wireless user devices. The wireless communication networks have wireless access nodes that exchange wireless signals with the wireless user devices using wireless network protocols, such as protocols described in various telecommunication standards promulgated by 3GPP.

To increase network coverage and support use cases that are beyond the capabilities of ground-based (terrestrial) infrastructure, 3GPP has released standards that integrate non-terrestrial networks (NTNs) into the 5G NR framework.

Multicast-Broadcast Services (MBS) refer to services that enable the delivery of multimedia content, such as audio, video, and data, to a wide audience over, e.g., wireless communication networks. MBS services over wireless communication networks enable users to receive multimedia content on their smartphones, tablets, and other mobile devices, providing information and communication services while on the go. MBS services encompass a range of services and technologies designed to distribute multimedia content efficiently and reach a large audience simultaneously.

### SUMMARY

According to one aspect of the present disclosure, a method to be performed by an access node for communicating MBS services in a non-terrestrial network (NTN) is disclosed. In one aspect, the method can include receiving an information element (IE) including MBS service area information indicating one or more MBS service areas in an NTN serving cell.

Other aspects include UE, apparatuses, systems, and computer programs for performing the aforementioned method.

The method can include other optional features. For example, in some implementations, at least one of the one or more MBS service areas is smaller than a coverage area of the NTN serving cell.

In some implementations, the MBS service area information includes a Synchronization Signal Block (SSB) list including one or more SSB groups, each SSB group (i) including one or more SSBs, and (ii) is associated with a respective MBS service area among the one or more MBS service areas or a respective transmission beam.

In some implementations, the MBS service area information includes an MBS coverage identifier (ID) list including one or more MBS service area coverage IDs, each MBS service area coverage ID is associated with a respective MBS service area among the one or more MBS service areas, wherein each MBS service area includes a reference location specifying a respective MBS service area among the one or more MBS service areas.

In some implementations, each MBS service area further includes a distance parameter corresponding to the reference location.

In some implementations, the MBS service area information includes at least one of a Public Land Mobile Network (PLMN) list including one or more PLMN identifiers (IDs) or a Tracking Area (TA) list including TA IDs.

In some implementations, a PLMN ID in conjunction with a TA ID corresponds to a respective MBS service area among the one or more MBS service areas.

In some implementations, the IE is transmitted from a core network entity, wherein the receiving includes receiving the IE at an access node.

In some implementations, the core network entity includes an Access and Mobility Management Function (AMF) and the access node includes a base station.

According to another aspect of the present disclosure, a method to be performed by an access node for communicating MBS services in an NTN is disclosed. In one aspect, the method can include generating a System Information Block (SIB) including a Multicast-Broadcast Services (MBS) coverage area information indicating one or more MBS service areas in a non-terrestrial network (NTN) serving cell, wherein an MBS service area of the one or more MBS service areas is identified by a respective MBS service area coverage identifier (ID); and transmitting the SIB to a user equipment (UE) in a signaling message.

Other aspects include base stations, apparatuses, systems, and computer programs for performing the aforementioned method.

The method can include other optional features. For example, in some implementations, at least one of the one or more MBS service areas is smaller than a coverage area of the NTN serving cell.

In some implementations, generating the SIB further includes associating each MBS service area coverage ID with at least one respective MBS session ID.

In some implementations, the SIB is a new SIB or an existing SIB.

In some implementations, the generating and the transmitting are performed by a base station.

According to another aspect of the present disclosure, a method to be performed by an access node for communicating MBS services in an NTN is disclosed. In one aspect, the method can include generating a Multicast-Broadcast Services (MBS) session information element (IE) indicating (i) an MBS session identifier (ID) of an MBS session and (ii) one or more Synchronization Signal Blocks (SSBs) corresponding to the MBS session ID, wherein the MBS session IE further includes information associating each SSB of the one or more SSBs is associated with a respective transmission beam; and transmitting the MBS session information IE to a user equipment (UE) in a signaling message.

Other aspects include base stations, apparatuses, systems, and computer programs for performing the aforementioned method.

The method can include other optional features. For example, in some implementations, the generating and the transmitting are performed by a base station.

According to another aspect of the present disclosure, a method to be performed by an access node for communicating MBS services in an NTN is disclosed. In one aspect, the method can include generating a Multicast-Broadcast Services (MBS) session information element (IE) indicating an MBS session identifier (ID) of an MBS session, wherein the MBS session ID is specified by temporary Mobile Group Identity (TMGI) information, the MBS session IE further including a field indicating presence of an MBS service area within a non-terrestrial network (NTN) serving cell, the MBS service area corresponding to the MBS session identifier (ID); and transmitting the MBS session information IE to a user equipment (UE) in a signaling message.

Other aspects include base stations, apparatuses, systems, and computer programs for performing the aforementioned method.

The method can include other optional features. For example, in some implementations, the generating and the transmitting are performed by a base station.

According to another aspect of the present disclosure, a method to be performed by an access node for communicating MBS services in an NTN is disclosed. In one aspect, the method can include transmitting, using a Multicast Control Channel (MCCH) signal, an information element (IE) including Multicast-Broadcast Services (MBS) coverage information associated with an MBS service area in a non-terrestrial network (NTN) serving cell, the MCCH signal corresponding to the MBS service area.

Other aspects include base stations, apparatuses, systems, and computer programs for performing the aforementioned method.

The method can include other optional features. For example, in some implementations, the MBS service area is smaller than a coverage area of the NTN serving cell.

According to another aspect of the present disclosure, a method to be performed by a UE for receiving MBS services in an NTN cell is disclosed. In one aspect, the method can include receiving an information element (IE) including Multicast-Broadcast Services (MBS) service area information indicating one or more MBS service areas in a non-terrestrial network (NTN) serving cell.

Other aspects include UEs, apparatuses, systems, and computer programs for performing the aforementioned method.

The method can include other optional features. For example, in some implementations, at least one of the one or more MBS service areas is smaller than a coverage area of the NTN serving cell.

In some implementations, the MBS service area information includes a Synchronization Signal Block (SSB) list including one or more SSB groups, each SSB group (i) including one or more SSBs, and (ii) is associated with a respective MBS service area among the one or more MBS service areas and a respective transmission beam.

In some implementations, the MBS service area information includes an MBS coverage identifier (ID) list including one or more MBS service area coverage IDs, each MBS service area coverage ID being associated with a respective MBS service area among the one or more MBS service areas, wherein each MBS service area includes a reference location specifying a respective MBS service area among the one or more MBS service areas.

In some implementations, each MBS service area further includes a distance parameter corresponding to a respective reference location.

In some implementations, the MBS service area information includes a Public Land Mobile Network (PLMN) list including at least one of one or more PLMN identifiers (IDs) or a Tracking Area (TA) list including TA IDs.

In some implementations, a PLMN ID in conjunction with a TA ID corresponds to a respective MBS service area among the one or more MBS service areas.

In some implementations, the IE is transmitted from a base station, and wherein the receiving includes receiving the IE at a user equipment (UE).

According to another aspect of the present disclosure, a method to be performed by a UE for receiving MBS services in an NTN cell is disclosed. In one aspect, the method can include: receiving a System Information Block (SIB) including a Multicast-Broadcast Services (MBS) coverage area information indicating one or more MBS service areas in a non-terrestrial network (NTN) serving cell, wherein an MBS service area is identified by a respective MBS service area coverage identifier (ID).

Other aspects include UEs, apparatuses, systems, and computer programs for performing the aforementioned method.

The method can include other optional features. For example, in some implementations, at least one of the one or more MBS service areas is smaller than a coverage area of the NTN serving cell.

In some implementations, each MBS service area coverage ID is associated with a respective MBS session ID.

In some implementations, the SIB is a new SIB or an existing SIB.

In some implementations, the receiving includes receiving the SIB at a user equipment (UE).

According to another aspect of the present disclosure, a method to be performed by a UE for receiving MBS services in an NTN cell is disclosed. In one aspect, the method can include: receiving an MBS session information element (IE) indicating (i) an MBS session identifier (ID) of an MBS session and (ii) one or more Synchronization Signal Blocks (SSBs) corresponding to the MBS session, wherein the MBS session IE further includes information associating each SSB of the one or more SSBs with a respective transmission beam.

Other aspects include UEs, apparatuses, systems, and computer programs for performing the aforementioned method.

The method can include other optional features. For example, in some implementations, the receiving includes receiving the MBS session information IE at a user equipment (UE).

According to another aspect of the present disclosure, a method to be performed by a UE for receiving MBS services in an NTN cell is disclosed. In one aspect, the method can include: receiving an MBS session information element (IE) an MBS session identifier (ID) of an MBS session, wherein the MBS session ID is specified by temporary Mobile Group Identity (TMGI) information, the MBS session information IE further including a field indicating presence of an MBS service area within a non-terrestrial network (NTN) serving cell, the MBS service area corresponding to the MBS session identifier (ID).

Other aspects include UEs, apparatuses, systems, and computer programs for performing the aforementioned method.

The method can include other optional features. For example, in some implementations, the MBS service area is smaller than a coverage area of the NTN serving cell.

In some implementations, the receiving includes receiving the MBS session information IE at a user equipment (UE).

According to another aspect of the present disclosure, a method to be performed by a UE for receiving MBS services in an NTN cell is disclosed. In one aspect, the method can include: receiving, using a Multicast Control Channel (MCCH) signal, an information element (IE) including Multicast-Broadcast Services (MBS) coverage information associated with an MBS service area in a non-terrestrial network (NTN) serving cell, the MCCH signal corresponding to the MBS service area.

Other aspects include UEs, apparatuses, systems, and computer programs for performing the aforementioned method.

The method can include other optional features. For example, in some implementations, the MBS service area is smaller than a coverage area of the NTN serving cell.

In some implementations, the receiving includes receiving the IE at a UE.

According to another aspect of the present disclosure, a method to be performed by a UE for receiving MBS services in an NTN cell is disclosed. In one aspect, the method can include: receiving information corresponding to a non-terrestrial network (NTN) neighboring cell, the information indicating that a Multicast-Broadcast Services (MBS) service is provided in a particular service area of the NTN neighboring cell; and determining, based at least on the information indicating that the MBS service is provided in the particular service area of the NTN neighboring cell, whether to initiate a unicast transmission for the MBS service in the NTN neighboring cell or continue to receive the MBS service in a multicast transmission in the NTN neighboring cell.

Other aspects include UEs, apparatuses, systems, and computer programs for performing the aforementioned method.

The method can include other optional features. For example, in some implementations, the particular service area is smaller than a coverage area of the NTN neighboring cell.

In some implementations, determining whether to initiate the unicast transmission or continue to receive the MBS service in the multicast transmission includes: moving to the NTN neighboring cell; determining that a location of a user equipment (UE) is outside of the particular service area in the NTN neighboring cell; and in response to the determining, initiating the unicast transmission.

In some implementations, determining whether to initiate the unicast transmission or continue to receive the MBS service in the multicast transmission further includes: moving to the NTN neighboring cell; determining that a location of a user equipment (UE) is within the particular service area in the NTN neighboring cell; and in response to the determining, receiving, in an idle or an inactive state, the MBS service.

In some implementations, the receiving and determining are performed by a user equipment (UE).

According to another aspect of the present disclosure, a method to be performed by a UE for receiving MBS services in an NTN cell is disclosed. In one aspect, the method can include: receiving information corresponding to a neighboring non-terrestrial network (NTN) cell, the information indicating a Frequency Specific Area Identity (FSAI) associated with the neighboring NTN cell, the FSAI corresponding to Multicast-Broadcast Services (MBS) coverage information indicating one or more MBS service areas of one or more MBS services in the neighboring NTN cell and respective frequencies; determining, based on a location of a user equipment (UE) in a particular service area among the one or more MBS service areas, that a particular frequency corresponding to an MBS service of interest among the one or more MBS services is available in the particular service area, the particular frequency being different from a current serving frequency; and selecting the particular frequency as a new serving frequency in the neighboring NTN cell.

Other aspects include UEs, apparatuses, systems, and computer programs for performing the aforementioned method.

The method can include other optional features. For example, in some implementations, the receiving, determining, and selecting are performed by a UE.

According to another aspect of the present disclosure, a method to be performed by a UE for receiving MBS services in an NTN cell is disclosed. In one aspect, the method can include: receiving information corresponding to a neighboring non-terrestrial network (NTN) cell, the information indicating a Frequency Specific Area Identity (FSAI) associated with the neighboring NTN cell, the FSAI corresponding to Multicast-Broadcast Services (MBS) coverage information indicating one or more MBS service areas of one or more MBS services in the neighboring NTN cell; determining, based on a location of a user equipment (UE) in a particular service area among the one or more MBS service areas, whether a current serving frequency of the UE is available for an MBS service of interest among the one or more MBS services in the particular service area; and in response to the determining, prioritizing one of the current serving frequency or a second frequency that is different than the current serving frequency in the neighboring NTN cell.

Other aspects include UEs, apparatuses, systems, and computer programs for performing the aforementioned method.

The method can include other optional features. For example, in some implementations, prioritizing one of the current serving frequency or the second frequency includes: in response to determining that the current serving frequency is available for the MBS service of interest in the particular service area, selecting the current serving frequency to receive the MBS service of interest.

In some implementations, prioritizing one of the current serving frequency or the second frequency includes: in response to determining that the MBS service of interest in the particular service area is served by the second frequency, selecting the second frequency as a new serving frequency.

In some implementations, the receiving, determining, and prioritizing are performed by a user equipment (UE).

### BRIEF DESCRIPTION OF THE DRAWINGS

FIG. 1 illustrates an example non-terrestrial network, according to some implementations.

FIGS. 2A-2D illustrate example processes of communicating MBS services in an NTN, according to some implementations.

FIG. 3A illustrates example MBS service area information, according to some implementations.

FIG. 3B illustrates another example MBS service area information, according to some implementations.

FIG. 4A illustrates example MBS service areas associated with respective SSB groups, according to some implementations.

FIG. 4B illustrates example MBS service areas associated with respective coverage IDs, according to some implementations.

FIG. 5A illustrates an example association between an SIB and an MBS session, according to some implementations.

FIG. 5B illustrates an example association between a beam and an MBS session, according to some implementations.

FIG. 5C illustrates an example association between a TMGI and an MBS session, according to some implementations.

FIG. 6 illustrates example MBS service areas associated with respective MCCHs, according to some implementations.

FIG. 7 illustrates an example process of communicating MBS services in an NTN cell, according to some implementations.

FIG. 8 illustrates example MBS service areas in an NTN neighboring cell, according to some implementations.

FIG. 9 illustrates an example process of receiving MBS services in an NTN cell, according to some implementations.

FIG. 10A illustrates an example association between FSAI and a combination of the deployed frequencies and MBS coverage information, according to some implementations.

FIG. 10B illustrates an example association between FSAI and MBS coverage information, according to some implementations.

FIG. 11 illustrates an example process of receiving MBS services in an NTN cell, according to some implementations.

FIG. 12 illustrates an example process of receiving MBS services in an NTN cell, according to some implementations.

FIG. 13 is a block diagram of an example UE, according to some implementations.

FIG. 14 is a block diagram of an example access node, according to some implementations.

FIG. 15 is a block diagram of an example apparatus, according to some implementations.

Like reference symbols in the various drawings indicate like elements.

### DETAILED DESCRIPTION

This disclosure describes methods and systems for multicast-broadcast services (MBS) in NTNs, enabling provision of MBS service within a service area (SA), which can be smaller than a coverage area of an NTN cell in some implementations.

The disclosed techniques describe configuration of MBS SAs using an Ng interface. In some implementations, the MBS service area information can include a Synchronization Signal Block (SSB) list, which is a list of SSB groups. Each SSB group corresponds to a different service area and a different transmission beam, with a service area and a transmission beam corresponding to each other. In some implementations, the MBS service area information can include an MBS coverage identifier (ID) list, which is a list of MBS service area coverage IDs. Each MBS service area coverage ID is associated with a respective MBS service area. Each MBS service area includes a reference location of an MBS service area. In some implementations, each MBS service area additionally includes a distance parameter associated with the reference location. In some implementations, the MBS service area information includes a Public Land Mobile Network (PLMN) list that is a list of PLMN IDs, and a Tracking Area (TA) list that is a list of TA IDs. Each PLMN ID and TA ID is associated with an MBS service area. In some implementations, the MBS service area information is transmitted from a core network entity (e.g., Access and Mobility Management Function (AMF)) to an access node (e.g., a base station such as a next generation node B (gNB)).

The disclosed techniques also describe configuration of MBS SAs using a Uu interface. In some implementations, MBS coverage information can be included in a System Information Block (SIB), e.g., a new SIB or an existing SIB, which is transmitted from an access node (e.g., a gNB) to a user equipment (UE) in a signaling message (e.g., Radio Resource Control (RRC) signaling). Each MBS service area is identified by an MBS service area coverage ID, which is further associated with an MBS session ID. In some implementations, the MBS coverage information of each MBS service area can be included in an SSB, which is associated with a transmission beam. A service area and a transmission beam correspond to each other. Each transmission beam is associated with a respective MBS session ID. In some implementations, a UE can obtain PLMN information or country information from temporary Mobile Group Identity (TMGI) information. The UE can identify an MBS service area where the UE is located that corresponds to the PLMN information or the country information. The identified MBS service area is associated with an MBS session ID.

The techniques of the disclosure describe correspondence between a Multicast Control Channel (MCCH) and an MBS service area, which is different from correspondence between a MCCH and a cell in existing techniques.

The techniques of the disclosure describe continuing to receive an MBS service of interest in an NTN neighboring cell after a UE moves from a serving cell (e.g., either a terrestrial network (TN) serving cell or an NTN serving cell) to the NTN neighboring cell. In some implementations, the UE obtains MBS coverage information indicating MBS service areas in the NTN neighboring cell. If the UE moves into the NTN neighboring cell while being outside of a service area of the MBS service of interest, the UE can initiate a unicast transmission to receive the MBS service of interest. If the UE moves into the service area of the MBS service of interest in the NTN neighboring cell, the UE can continue to receive the MBS service in a multicast transmission. In some examples, the UE can continue to receive the MBS service in the multicast transmission when the UE is in an idle/inactive state.

The techniques of the disclosure describe a selection of a frequency (different from the current serving frequency) for an MBS service of interest in an NTN neighboring cell after a UE moves from a serving cell (e.g., either a TN serving cell or an NTN serving cell) to the NTN neighboring cell. The network can provide a mapping between a Frequency Specific Area Identity (FSAI) and MBS coverage information as well as a frequency for each MBS service in an NTN neighboring cell. The UE can obtain MBS coverage information and a frequency for each MBS service based on FSAI. If the UE moves from the serving cell to a particular MBS service area in the NTN neighboring cell, the UE determines whether a particular frequency (different from the current serving frequency) for an MBS service of interest is available in the particular MBS service area. If the particular frequency for the MBS service of interest is available, the UE can select the particular frequency as a new serving frequency in the neighboring NTN cell.

The techniques of the disclosure describe a selection of a frequency (the current serving frequency or another frequency different from the current serving frequency) for an MBS service of interest in an NTN neighboring cell after a UE moves from a serving cell (either a TN serving cell or an NTN serving cell) to the NTN neighboring cell. The network can provide a mapping between FSAI and MBS coverage information associated with the NTN neighboring cell. The UE can obtain MBS coverage information and a frequency for each MBS service based on FSAI. If the UE moves from the serving cell to a particular MBS service area in the NTN neighboring cell, the UE determines whether the current serving frequency for an MBS service of interest is available in the particular MBS service area. If the current serving frequency for the MBS service of interest is available in the particular MBS service area, the UE can select the current serving frequency to receive the MBS service of interest in the NTN neighboring cell. If the current serving frequency for the MBS service of interest is unavailable in the particular MBS service area, the UE can select another frequency as a new serving frequency in the NTN neighboring cell.

In general, an NTN includes a network, or a segment thereof, which uses airborne or space-borne platforms (e.g., non-geo-stationary satellites) to implement, or augment, access nodes or base stations. The airborne platform in an NTN can serve to connect access nodes to user equipment (UEs) in the coverage area of the airborne platform. An NTN can include satellites, high-altitude platform systems (HAPS), an air-to-ground network, and low-altitude unmanned aerial vehicles (UAVs), among other equipment. One of the objectives of 3GPP Release 19 is to support MBS service in an NTN. The MBS service can leverage a large coverage of the NTN compared to a TN. The techniques herein can provide MBS service within a service area. The service area can be smaller than a coverage area of an NTN cell. For example, a single NTN cell can include one or more service areas, and each service area corresponds to a respective MBS service.

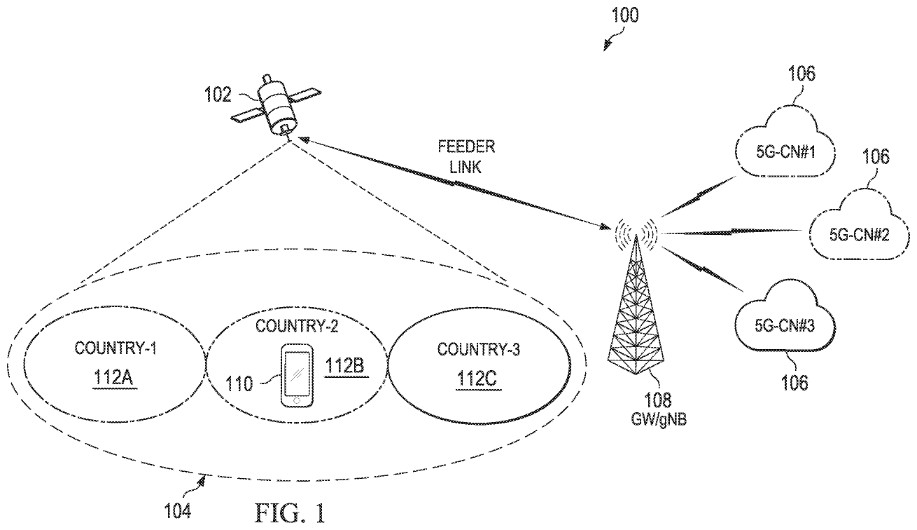

FIG. 1 illustrates an example non-terrestrial network 100, according to some implementations. Generally, the non-terrestrial network 100 can include any network that uses non-terrestrial components, such as satellites, airplanes, and UAVs, to provide network coverage to a UE. In the example of FIG. 1, the non-terrestrial network 100 includes a satellite 102 (“satellite 102”) that has a moving coverage area 104 (an NTN cell). The non-terrestrial network 100 is coupled to one or more core networks 106, e.g., 4G or 5G core networks, via one or more terrestrial base stations 108 (e.g., access node 1700 in FIG. 17)). The link between the satellite 102 and a terrestrial base station 108 is called a feeder link.

The non-terrestrial network 100 can serve UEs that are located in a coverage area of one of the non-terrestrial components of the network. For example, the non-terrestrial network 100 can serve a UE 110 when the UE is located within the coverage area 104. The UE 110 and any other UE in the system may be, for example, laptop computers, smartphones, tablet computers, machine-type devices, intelligent transportation systems, IoT devices, NB-IoT/eMTC devices, or any other wireless devices with or without a user interface. The non-terrestrial network 100 can provide the UE 110 with network connectivity to a broader network (not shown in FIG. 1), such as the Internet.

In some implementations, the satellite 102 provides network services to UEs via a service link. The satellite 102 can implement either a transparent payload or a regenerative payload. A transparent payload refers to an arrangement in which the satellite 102 receives a signal and transmits an amplified version of the signal. For example, the satellite 102 receives uplink communications from the UE 110 on service link frequencies and transmits an amplified version of the signal to the core network 106 on feeder link frequencies, or may receive downlink communications from the core network 106 on the feeder link frequencies and transmit an amplified version of the signal to the UE 110 on the service link frequencies.

A regenerative payload refers to an arrangement in which the satellite 102 acts as a distributed unit (DU). In this arrangement, the satellite 102 regenerates received signals with signal-processing techniques (e.g., demodulation, decoding, switching, encoding, modulation, etc.) before being retransmitted. The satellite 102 generates one or more beams over a service area bounded by its field of view, which can depend on the antenna diagram and minimum elevation angle of the satellite. The coverage areas of the beams are typically elliptically shaped, e.g., the coverage area 104.

In some implementations, the satellite 102 provides MBS to UEs. For example, the satellite 102 can provide a first MBS service within a first MBS area 112A, a second MBS service within a second MBS area 112B, and a third MBS service within a third MBS area 112C. The MBS areas 112A, 112B, and 112C are smaller than a coverage area of an NTN cell 104 (the coverage area 104).

The example shown in FIG. 1 is not intended to limit the exemplary embodiments in any way. The non-terrestrial network 100 may be integrated with a 5G NR radio access network (RAN) and/or other networks in any of a variety of manners. For example, the non-terrestrial network 100 may include a low earth orbit (LEO) constellation including an array of satellites and gateways with broad interconnectivity via ground-to-ground station (G2G) links, satellite-to-satellite (S2S) links, ground-to-satellite (G2S) links, and satellite-to-ground (S2G) links. Other types of satellite-based NTNs include geostationary-orbiting (GEO) satellites or medium-earth-orbiting (MEO) satellites. Additionally, the non-terrestrial network 100 may include more than one satellite that provides coverage to the UE 110 at overlapping or different times.

### Finer Granularity of MBS Service Area

The granularity of an MBS service area refers to the level of detail or precision in defining the coverage area of an MBS service. It describes how finely the service area is divided or segmented within the NTN. In some implementations, a single NTN cell can include multiple MBS service areas. In some implementations, one or more MBS service areas can be smaller than a coverage area of the NTN cell. A UE can, based on MBS coverage information, start or stop an MBS broadcast service within an NTN cell.

### Ng Interface

The Ng interface represents an interface between the RAN and the core network (e.g., 5G Core Network). The Ng interface is responsible for the exchange of control and user plane data between the RAN (e.g., a base station, gNB) and various entities in the core network.

A core network entity can send, to a base station in the access network, MBS service area configuration information, which can be associated with an MBS service area identifier (ID), a Public Land Mobile Network (PLMN)/Country code, or an MBS session ID.

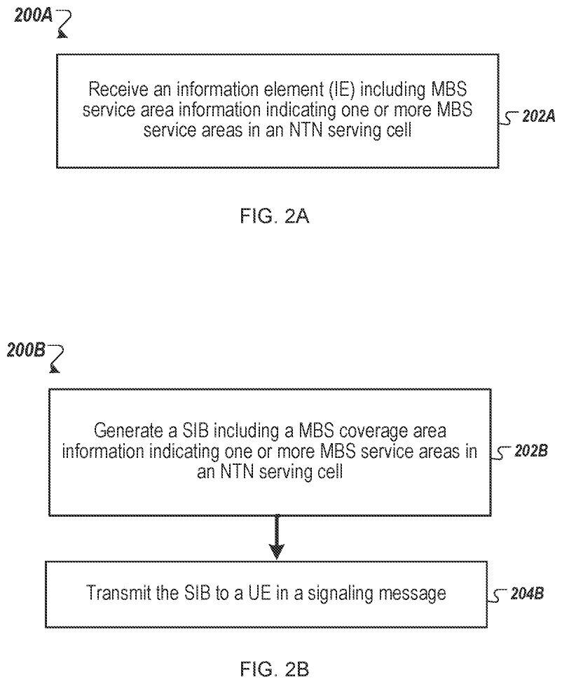

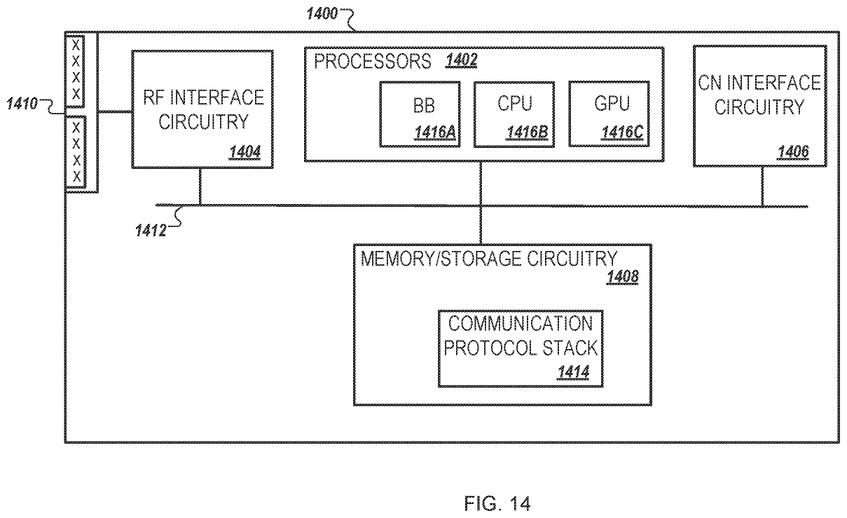

FIG. 2A illustrates an example process of communicating MBS services in an NTN, according to some implementations. The process 200A is described as being performed by a base station, such as base station 108 of FIG. 1 or base station 1400 of FIG. 14. The example process 200A shown in FIG. 2A can be modified or reconfigured to include additional, fewer, or different steps (not shown in FIG. 2A), which can be performed in the order shown or in a different order.

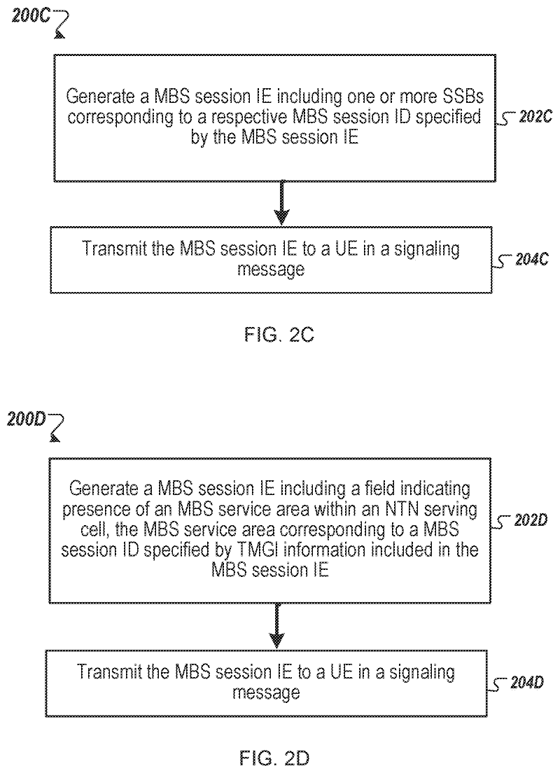

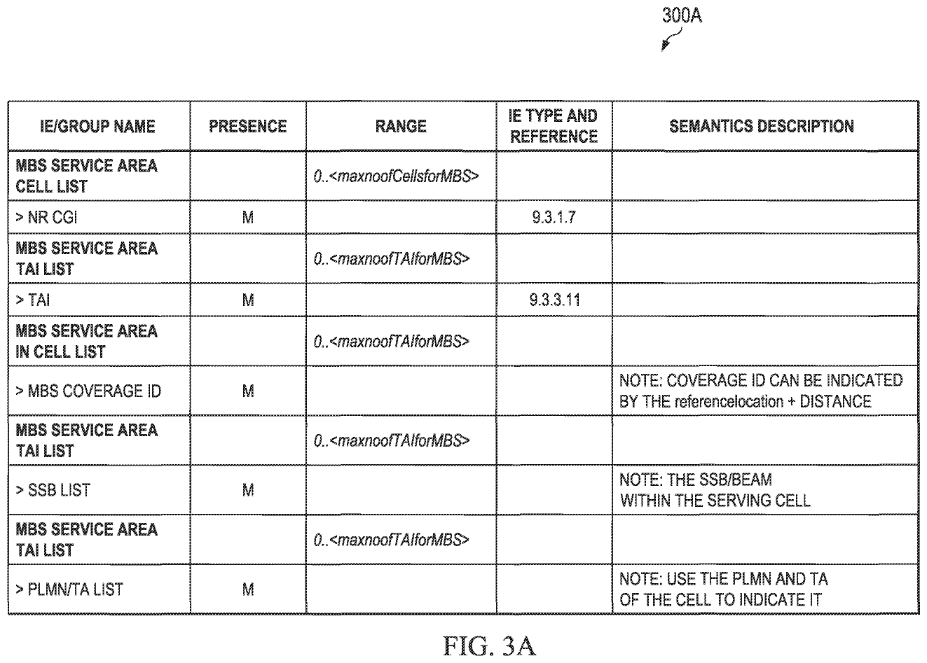

At 202A, a base station (e.g., the base station or access node 108 of FIG. 1 or 1400 of FIG. 14) receives an information element (IE) from a core network entity. The core network entity can be an Access and Mobility Management Function (AMF) in a core network (e.g., any of core networks 106 of FIG. 1). The IE includes MBS service area information (e.g., as shown by FIG. 3A or FIG. 3B, which corresponds to the MBS Service Area information IE in clause 9.3.1.209 of TS 38.413) indicating one or more MBS service areas in an NTN serving cell. The IE is a unit of data that is structured according to a specific format, and has a defined purpose within a protocol. IEs are used to exchange control information between network entities. In some implementations, the MBS service areas are smaller than a coverage area of the NTN serving cell.

[symbol]

FIGS. 3A and 3B illustrate examples of the MBS Service Area information IE (see clause 9.3.1.209 of 3GPP TS 38.413) modified to support MBS in NTNs. As described above, the MBS Service Area information IE is received by a base station from a core network entity. As shown in FIG. 3A, the MBS service area information IE 300A can further include an “MBS coverage ID”, an “SSB list”, or/and a “PLMN/TA list”. As shown in FIG. 3B, the MBS service area information IE 300B can further include an “MBS coverage ID”. The “SSB list” or/and the “PLMN/TA list” can be included as sub-options of “MBS coverage ID”. The “MBS coverage ID”, “SSB list”, or “PLMN/TA list” can further include MBS coverage information for each MBS service. Each MBS coverage ID, SSB, or PLMN ID/TA ID can include MBS coverage information of a different MBS service.

The MBS service area information defines specific geographical regions where an MBS service is available for broadcast/multicast transmission. The MBS service area information outlines the boundaries of the service areas where users can reliably receive the MBS service.

In some examples, the granularity of MBS service areas can be configured at a beam level (e.g., in an SSB list). MBS coverage information is included in a System Information Block (SIB) (e.g., a new SIB or an existing SIB). MBS coverage information refers to data about the geographical areas covered by the MBS service.

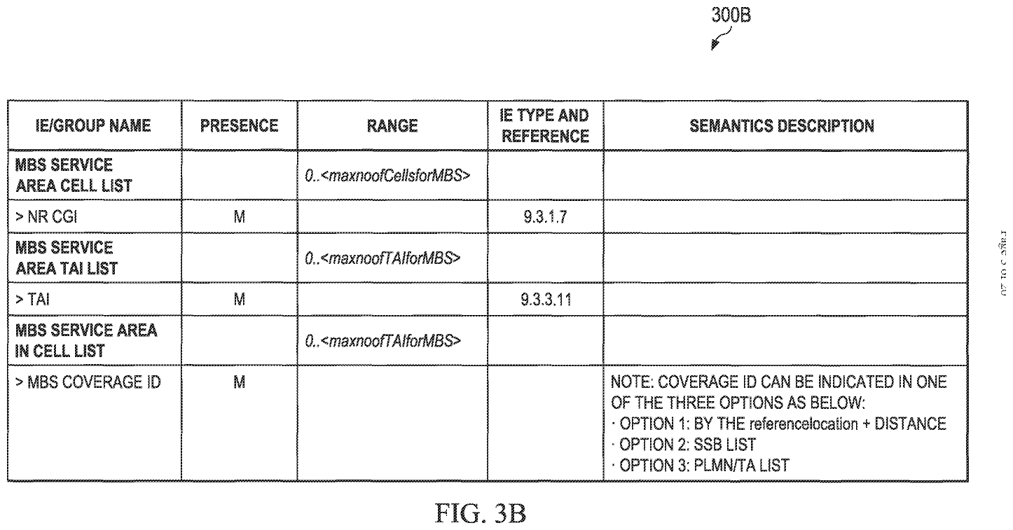

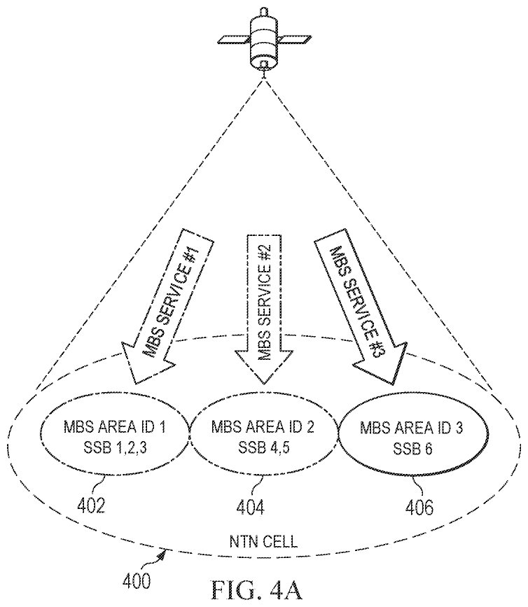

FIG. 4A illustrates example MBS service areas associated with respective SSB groups, according to some implementations. As shown in FIG. 4A, an NTN cell 400 includes the first MBS service area 402, the second MBS service area 404, and the third MBS service area 406. A first SSB group, including the first SSB (SSB 1), the second SSB (SSB 2), and the third SSB (SSB 3), is associated with the first MBS service area 402. The first SSB group corresponds to a first transmission beam. A second SSB group, including the fourth SSB (SSB 4) and the fifth SSB (SSB 5), is associated with the second MBS service area 404. The second SSB group corresponds to a second transmission beam. A third SSB group, including the sixth SSB (SSB 6), is associated with the third MBS service area 406. The third SSB group corresponds to a third transmission beam. The first SSB, the second SSB, and the third SSB include MBS coverage information of the first MBS service area 402. The fourth SSB and the fifth SSB include MBS coverage information of the second MBS service area 404. The sixth SSB includes MBS coverage information of the third MBS service area 406.

In some examples, the granularity of MBS service areas can be configured at a coverage level, and the MBS coverage information of each MBS service area is included in a respective coverage ID. As shown in FIG. 4B, the first coverage ID is associated with the first MBS service area 402, the second coverage ID is associated with the second MBS service area 404, and the third coverage ID is associated with the third MBS service area 406. The first coverage ID includes MBS coverage information of the first MBS service area 402. The second coverage ID includes MBS coverage information of the second MBS service area 404. The third coverage ID includes MBS coverage information of the third MBS service area 406.

In some examples, the granularity of MBS service areas can be configured at a country level (e.g., Mobile Country Code (MMC) and Mobile Network Code (MNC) in a PLMN ID of TMGI). Each PLMN ID/TA ID is associated with an MBS service area.

### Uu Interface

The configuration of each MBS service area in an NTN cell can be provided from a base station to UEs via Radio Resource Control (RRC) signaling as described in 3GPP TS 38.331.

FIG. 2B illustrates an example process of communicating MBS services in an NTN serving cell, according to some implementations. The process 200B is described as being performed by a base station, such as base station 108 of FIG. 1 or base station 1400 of FIG. 14. In some implementations, a base station broadcasts the MBS service information using one or more airborne platforms (e.g., satellite 102 of FIG. 1) providing coverage in the NTN serving cell. The example process 200B shown in FIG. 2B can be modified or reconfigured to include additional, fewer, or different steps (not shown in FIG. 2B), which can be performed in the order shown or in a different order.

At 202B, a base station (e.g., the base station or access node 108 of FIG. 1 or 1400 of FIG. 14) generates an SIB including an MBS coverage area information indicating one or more MBS service areas in an NTN serving cell. Each MBS service area is identified by a respective MBS service area coverage ID. In some implementations, the SIB includes information associating the MBS coverage area indicated by the SIB with one or more MBS sessions, which are indicated by MBS session IDs (e.g., using an MBS-SessionInfo IE).

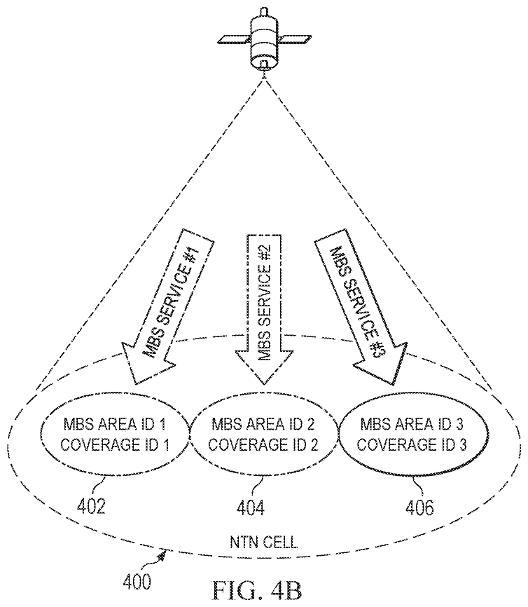

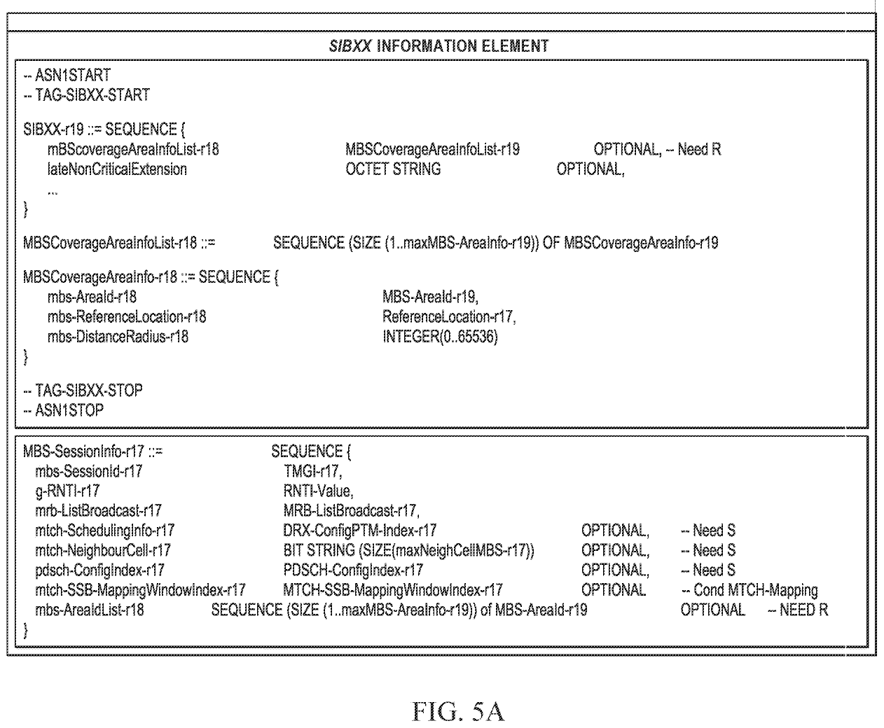

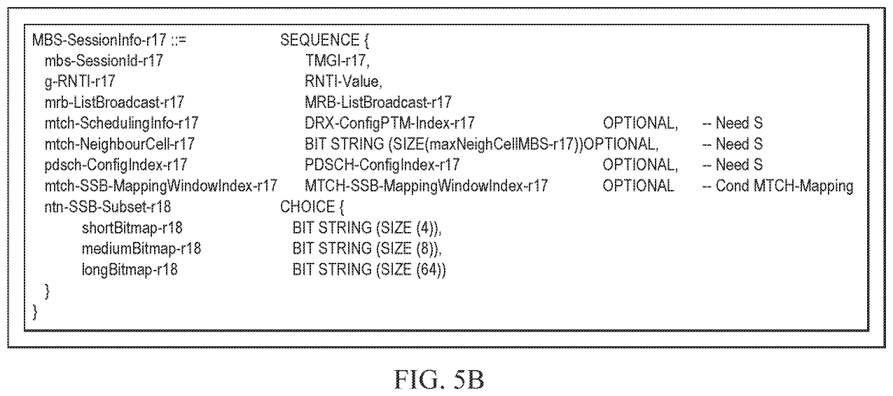

In some implementations, the SIB includes MBS coverage information of an MBS service area. The SIB can be a new SIB or an existing SIB. The MBS coverage information is identified by an MBS coverage ID. The MBS coverage ID is associated with each MBS session ID. The MBS coverage ID identifies the specific coverage area or cell where the MBS service is being broadcasted, while the session ID identifies individual user sessions or connections to the MBS service. Associating the coverage ID with each MBS session ID can be useful for tracking and managing user sessions within the network. FIG. 5A illustrates an example association between SIB and an MBS session, according to some implementations. As shown in FIG. 5A, an SIB includes (e.g., “SIBXX-r19”) MBS coverage information (e.g., “MBScoverageAreaInfoList-r18”) of an MBS service area. MBS coverage information of an MBS service area (e.g., “MBScoverageAreaInfo-r18”) includes an MBS coverage ID (e.g., “mbs-AreaId-r18”). A list of MBS coverage IDs (e.g., “mbs-AreaIdList-r18”) is included in an MBS session information IE (e.g., “MBS-SessionInfo-r17”), which includes a session ID (e.g., “mbs-SessionId-r17”). Thus, the MBS coverage ID (e.g., “mbs-AreaId-r18”) is associated with an MBS session ID (e.g., “mbs-SessionId-r17”).

In some examples, the MBS coverage information of a service area can include a reference location and a distance parameter (e.g., a radius) of the service area. For example, as shown in FIG. 5A, MBS coverage information of an MBS service area (e.g., “MBScoverageAreaInfo-r18”) can include a reference location (e.g., “mbs-ReferenceLocation-r18”) and a distance parameter (e.g., “mbs-DistanceRadius-r18”) of a service area. In some examples, the MBS coverage information can include information of a beam associated with the service area. In some examples, the MBS coverage information can include information of PLMN associated with the service area.

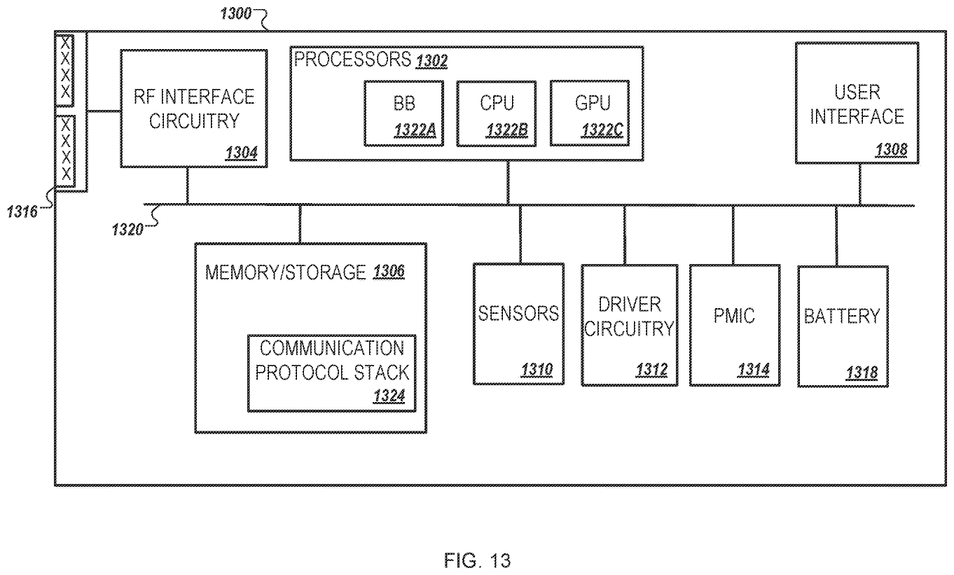

At 204B, the base station transmits the SIB to a UE (e.g., the UE 110 of FIG. 1 or the UE 1300 of FIG. 13) in a signaling message (e.g., Radio Resource Control (RRC) signaling message). In some implementations, the coverage information for the MBS service area (e.g., the MBS service area information IE) is broadcast to the UEs. However, in some implementations, the coverage information for the MBS service area is provided to one or more UEs via user service description (USD). A UE can acquire the coverage information for the MBS service area in either way, e.g., either upon receiving a broadcast message, or by receiving a USD message.

Upon receiving the SIB including the MBS coverage area information, a UE, based on its location in the NTN cell and the MBS service area (and/or MBS session) information, can detect and receive an MBS broadcast service in an MBS service area among the one or more MBS service areas indicated by the MBS service area information.

The association between the MBS coverage information and the MBS session ID can be provided in different implementations. In some implementations, the MBS coverage information of an MBS service can further include an MBS session ID list. MBS sessions identified by session IDs in the ID list can receive the MBS service. In some implementations, an MBS session configuration can further include MBS coverage information of an MBS service area. In some implementations, a new mapping table between the MBS coverage information of each MBS service area and MBS session IDs is included in an SIB, or in an MBS Broadcast Configuration in a Multicast Control Channel (MCCH). A UE can determine an MBS service area where the UE is located. The MBS coverage information is associated with a session ID, and thus the UE can receive an MBS service at its location in an MBS session identified by the session ID.

FIG. 2C illustrates another example process of communicating MBS services in an NTN serving cell, according to some implementations. The process 200C is described as being performed by a base station, such as base station 108 of FIG. 1 or base station 1400 of FIG. 14. In some implementations, a base station broadcasts the MBS service information using one or more airborne platforms (e.g., satellite 102 of FIG. 1) providing coverage in the NTN serving cell. The example process 200C shown in FIG. 2C can be modified or reconfigured to include additional, fewer, or different steps (not shown in FIG. 2C), which can be performed in the order shown or in a different order.

At 202C, a base station generates an MBS session information IE (e.g., MBS-SessionInfoList as specified in 3GPP TS 38.331 clause 6.3.6), including one or more SSBs corresponding to a respective MBS session ID specified by the MBS session information IE. Each SSB is associated with a respective transmission beam.

At 204C, the base station transmits the MBS session information IE to a UE (e.g., the UE 110 of FIG. 1 or the UE 1300 of FIG. 13) in a signaling message (e.g., Radio Resource Control (RRC) signaling message). Upon receiving the MBS session information IE, a UE processes the information to receive MBS service as described above with respect to FIG. 2B.

In some implementations, beam information can be associated with an MBS session. In some examples, MBS session information can further include beam information. FIG. 5B illustrates an example association between a beam and an MBS session, according to some implementations. As shown in FIG. 5B, an MBS session information element (e.g., MBS-SessionInfoList) can include “MBS-SessionInfo-r17” with information about one or more SSBs (“ntn-SSB-Subset-r18”) that correspond to an MBS session specified by an MBS session ID (e.g., “mbs-SessionId-r17”). In some implementations, the MBS session IE specifies beams that are associated with the SSBs, for example, using a bitmap (e.g., one or more of “shortBitmap-r18,” “mediumBitmap-r18,” or “longBitmap-r18”). In some examples, Physical Downlink Shared Channel (PDSCH) configured information (e.g., “pdsch-ConfigIndex-r17”) can further include beam information. Based on the detected SSB/beam at the location of UE, UE can identify MBS sessions associated with the detected beam and receive an MBS session of interest among the identified MBS sessions.

FIG. 2D illustrates another example process of communicating MBS services in an NTN serving cell, according to some implementations. The process 200D is described as being performed by a base station, such as base station 108 of FIG. 1 or base station 1400 of FIG. 14. In some implementations, a base station broadcasts the MBS service information using one or more airborne platforms (e.g., satellite 102 of FIG. 1) providing coverage in the NTN cell. The example process 200D shown in FIG. 2D can be modified or reconfigured to include additional, fewer, or different steps (not shown in FIG. 2D), which can be performed in the order shown or in a different order.

At 202D, a base station (e.g., the base station or access node 108 of FIG. 1 or 1400 of FIG. 14) generates an MBS session information IE (e.g., MBS-SessionInfoList as specified in 3GPP TS 38.331 clause 6.3.6) including a field indicating presence of an MBS service area within an NTN serving cell. In some implementations, the MBS service area is indicated by a corresponding MBS session ID, which is specified by TMGI information included in the MBS session information IE.

At 204D, the base station transmits the MBS session information IE to a UE (e.g., the UE 110 of FIG. 1 or the UE 1300 of FIG. 13) in a signaling message (e.g., Radio Resource Control (RRC) signaling message).

In some implementations, UE can, using the TMGI information (e.g., MMC and MNC in a PLMN ID of TMGI), identify UE's current country information or PLMN information based on its location, and match the associated MBS session ID configured by the TMGI information (e.g., a TMGI structure is defined in 3GPP TS 23.003) based on the country information or PLMN information. As shown in FIG. 5C, an MBS session information element (e.g., MBS-SessionInfoList) can include “MBS-SessionInfo-r17” with a field “mbsAreaWithinCell” indicating the presence of an MBS service area within an NTN cell. The field “mbsAreaWithinCell” can be determined based on country information or PLMN information. The field “mbsAreaWithinCell” can be “TRUE”, indicating the presence of an MBS service area in the NTN cell. Accordingly, the MBS session ID (e.g., “mbs-SessionId-r17”) can be obtained from TMGI information (e.g., “TMGI-r17”) in MBS-SessionInfo-r17.

### Different MCCH Configurations Per MBS SA

In some implementations, an MBS transmission can be configured differently in each MBS service area within an NTN cell. In different MBS service areas, a transmission beam for each Multicast Control Channel (MCCH) can be different, and a periodicity and a frequency resource of each MCCH transmission can also be different.

The MCCH is responsible for managing and controlling MBS sessions. The MCCH carries signaling information related to establishment, modification, and termination of MBS sessions, as well as information about the available MBS services and associated parameters.

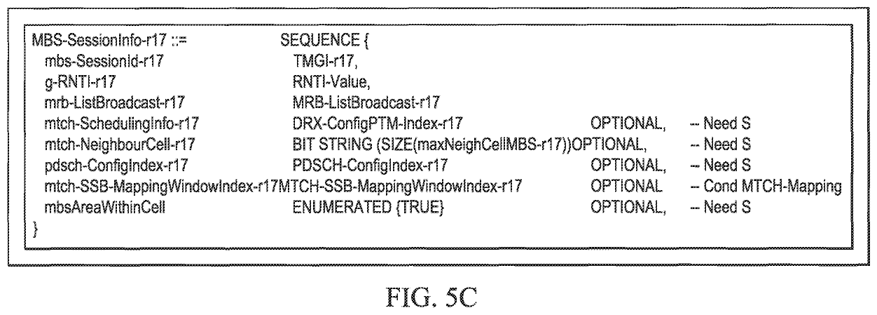

The network can provide an MCCH configuration for each MBS service area in an NTN cell. FIG. 6 illustrates example MBS service areas associated with respective MCCHs, according to some implementations. As shown in FIG. 6, when a UE is located in the first MBS service area 602, the UE monitors MCCH #1 604 to obtain a configuration for the first MBS service area 602. When the UE is located in the second MBS service area 606, the UE monitors MCCH #2 608 to obtain a configuration for the second MBS service area 606. When the UE is located in the third MBS service area 610, the UE monitors MCCH #3 612 to obtain a configuration for the third MBS service area 610. Transmission beams for respective MBS service areas are also different. For example, the first MBS service area 602 corresponds to a transmission beam associated with the first SSB, the second SSB, and the third SSB. The second MBS service area 606 corresponds to a transmission beam associated with the fourth SSB and the fifth SSB. The third MBS service area 610 corresponds to a transmission beam associated with the sixth SSB.

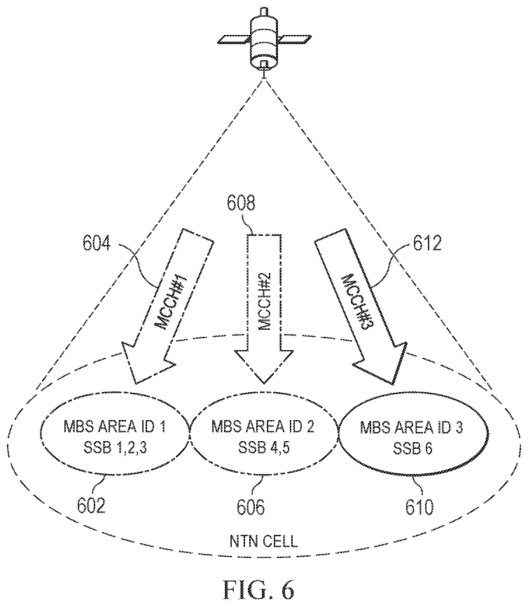

FIG. 7 illustrates an example process of communicating MBS services in an NTN cell, according to some implementations. The process 700 is described as being performed by a base station, such as base station 108 of FIG. 1 or base station 1400 of FIG. 14. In some implementations, a base station performs the broadcast using one or more airborne platforms (e.g., satellite 102 of FIG. 1) providing coverage in the NTN cell. The example process 700 shown in FIG. 7 can be modified or reconfigured to include additional, fewer, or different steps (not shown in FIG. 7), which can be performed in the order shown or in a different order.

At 702, the base station transmits, using a MCCH signal (e.g., MCCH #1, MCCH #2, or MCCH #3), an information element including MBS coverage information to UEs (e.g., the UE 110 of FIG. 1 or the UE 1300 of FIG. 13). The MBS coverage information is associated with an MBS service area (e.g., the first MBS service area 602, the second MBS service area 606, or the third MBS service area 610) in an NTN serving cell. The MCCH signal corresponds to the MBS service area (e.g., the first MBS service area 602, the second MBS service area 606, or the third MBS service area 610). In some implementations, the MBS service area (e.g., the first MBS service area 602, the second MBS service area 606, or the third MBS service area 610) is smaller than a coverage area of the NTN serving cell.

A UE, based on its location in a particular MBS service area within the NTN cell, monitors an MCCH signal corresponding to the particular MBS service area. The UE receives the information element including MBS coverage information of the particular MBS service area using the MCCH signal and receives an MBS service in the particular MBS service area.

### Service Continuity for MBS SA

### Unicast Transmission/Multicast Transmission

In some implementations, a UE, which is receiving an MBS service in an NTT serving cell, will move to an NTN neighboring cell. The UE receives NTN neighboring cell information, including MBS coverage information, for the NTN neighboring cell. Based on the MBS coverage information, the UE can determine whether to initiate a unicast transmission. For example, if the network provides the MBS service in a service area (in the same NTN neighboring cell) other than a service area where the UE is located after the UE moves to the NTN neighboring cell, the UE can initiate a unicast transmission. If the network provides the MBS service in a service area where the UE is located after the UE moves to the NTN neighboring cell, the UE can continue to receive the MBS service in a multicast transmission, e.g., when the UE is in an IDLE/INACTIVE state.

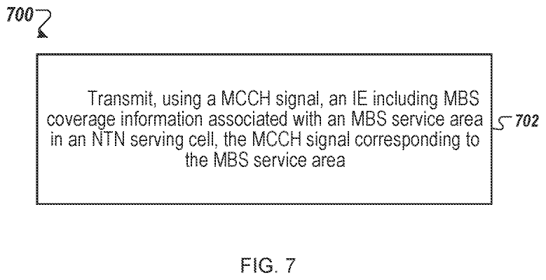

FIG. 8 illustrates example MBS service areas in an NTN neighboring cell, according to some implementations. A UE is located in a serving cell and is receiving MBS service #2. As shown in FIG. 8, the UE will move to the first MBS service area 802 or the third MBS service area 806 in an NTN neighboring cell 800. The MBS service #2 is only available in the second MBS service area 804. The UE can initiate a unicast transmission after the UE moves from the serving cell to the first MBS service area 802 or the third MBS service area 806 in the NTN neighboring cell. The unicast transmission refers to point-to-point communication between a single sender and a single receiver in a network. In unicast transmission, data is sent from one source to one destination, allowing for targeted communication between specific devices or users.

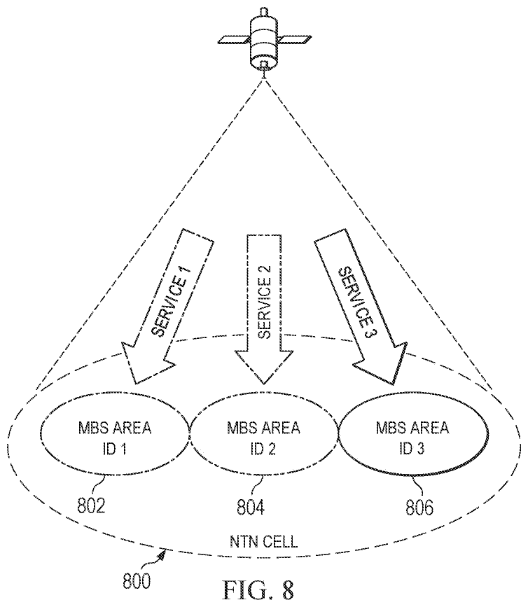

FIG. 9 illustrates an example process of receiving MBS services in an NTN cell, according to some implementations. The process 900 is described as being performed by a UE, such as UE 110 of FIG. 1 or UE 1300 of FIG. 13. The example process 900 shown in FIG. 9 can be modified or reconfigured to include additional, fewer, or different steps (not shown in FIG. 9), which can be performed in the order shown or in a different order.

At 902, the UE receives, in a serving cell, information corresponding to an NTN neighboring cell. The information indicates that an MBS service of interest is provided in a particular service area of the NTN neighboring cell. In some implementations, the particular service area is smaller than a coverage area of the NTN neighboring cell.

At 902, the UE determines, based on the received information, whether to initiate a unicast transmission for the MBS service of interest in the NTN neighboring cell or continue to receive the MBS service of interest in a multicast transmission in the NTN neighboring cell.

The UE moves from the serving cell to the NTN neighboring cell. If the UE is located outside of the particular service area in the NTN neighboring cell, the UE determines to initiate a unicast transmission to receive the MBS service of interest. If the UE is located within the particular service area in the NTN neighboring cell, the UE can receive the MBS service of interest in a multicast transmission and in an idle or inactive state.

### Mapping Between FSAI and MBS Coverage Information

### Inter-Frequency Deployment

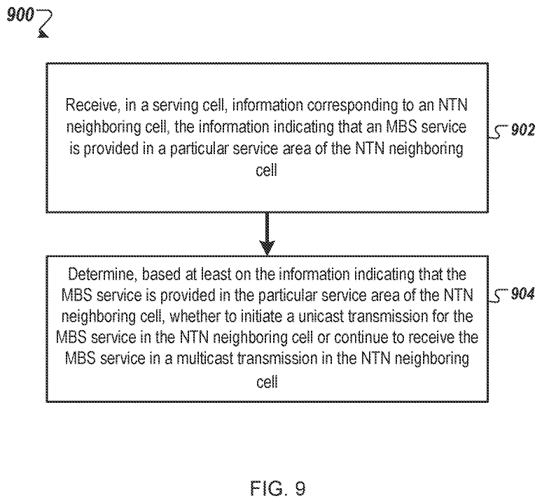

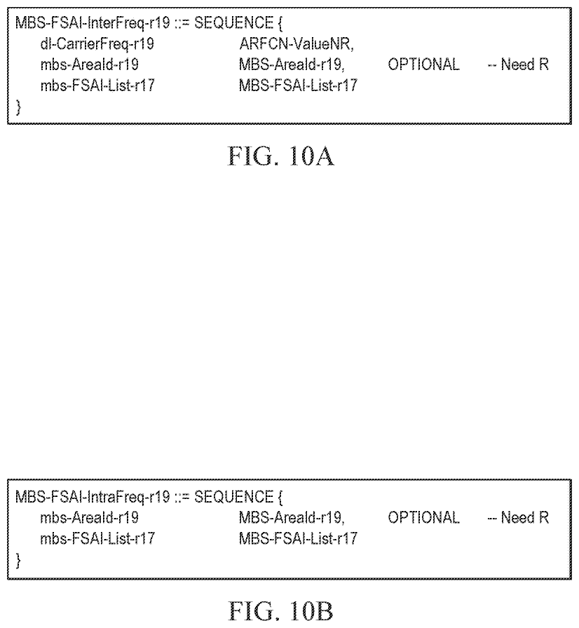

In some implementations, a UE is receiving an MBS service in a serving cell using a serving frequency, and the UE will move to an NTN neighboring cell. In some examples, the network provides a mapping between FSAI information and a combination of the deployed frequencies and MBS coverage information in the NTN neighboring cell. FSAI relates to the allocation of specific frequencies to serve particular geographic areas or zones within a network coverage area. As shown in FIG. 10A, in some implementations, an SIB information element (e.g., an SIB21 information element as described in 3GPP TS 38.331, which includes mapping between current and/or neighboring carrier frequencies and MBS FSAI) includes an “MSB-FSAI-InterFreq-r19” field, which provides a mapping between FSAI information (e.g., “mbs-FSAI-List-r17”) and a combination of the deployed frequencies (e.g., “dl-CarrierFreq-r19”) and MBS coverage information (e.g., “mbs-AreaId-r19”) in the NTN neighboring cell.

When the UE performs an MBS frequency prioritization during a cell reselection, the UE can identify a frequency available for an MBS service of interest based on its location in the NTN neighboring cell and the FSAI information. The identified frequency is different from the serving frequency. The UE prioritizes the identified frequency. For example, the UE selects the identified frequency as a new serving frequency to receive the MBS service of interest in the NTN neighboring cell.

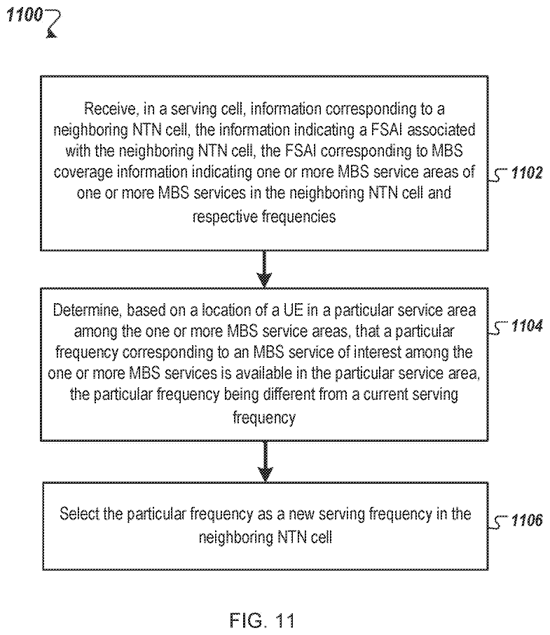

FIG. 11 illustrates an example process of receiving MBS services in an NTN cell, according to some implementations. The process 1100 is described as being performed by a UE, such as UE 110 of FIG. 1 or UE 1300 of FIG. 13. The example process 1100 shown in FIG. 11 can be modified or reconfigured to include additional, fewer, or different steps (not shown in FIG. 11), which can be performed in the order shown or in a different order.

At 1102, the UE receives, in a serving cell, information corresponding to a neighboring NTN cell. The information includes an FSAI associated with the neighboring NTN cell. The FSAI corresponds to MBS coverage information indicating one or more MBS service areas of one or more MBS services in the neighboring NTN cell and respective frequencies for the one or more MBS services.

At 1104, the UE determines, based on a location of UE in a particular service area among the one or more MBS service areas, that a particular frequency corresponding to an MBS service of interest among the one or more MBS services is available in the particular service area. The particular frequency is different from the current serving frequency.

At 1106, the UE selects the particular frequency as a new serving frequency in the neighboring NTN cell.

### Intra-Frequency Deployment

In some implementations, a UE is receiving an MBS service in a serving cell using a serving frequency, and the UE will move to an NTN neighboring cell. In some examples, the network provides a mapping between FSAI information and MBS coverage information in the NTN neighboring cell. 3GPP TS 38.331 describes an SIB21 information element. As shown in FIG. 10B, “MSB-FSAI-IntraFreq-r19” of the SIB21 information element provides a mapping between FSAI information (e.g., “mbs-FSAI-List-r17”) and MBS coverage information (e.g., “mbs-AreaId-r19”) in the NTN neighboring cell.

When the UE performs an MBS frequency prioritization during a cell reselection, the UE can determine whether the current serving frequency is available for an MBS service of interest in a service area where the UE is located in the NTN neighboring cell. If the current serving frequency is available for the MBS service of interest in the NTN neighboring cell, the UE prioritizes the current serving frequency, e.g., the UE selects the current serving frequency to receive the MBS service of interest in the NTN neighboring cell. If the current serving frequency is unavailable for the MBS service of interest in the NTN neighboring cell, the UE prioritizes a second frequency as a new serving frequency, e.g., the UE selects the second frequency as a new serving frequency to receive the MBS service of interest in the NTN neighboring cell.

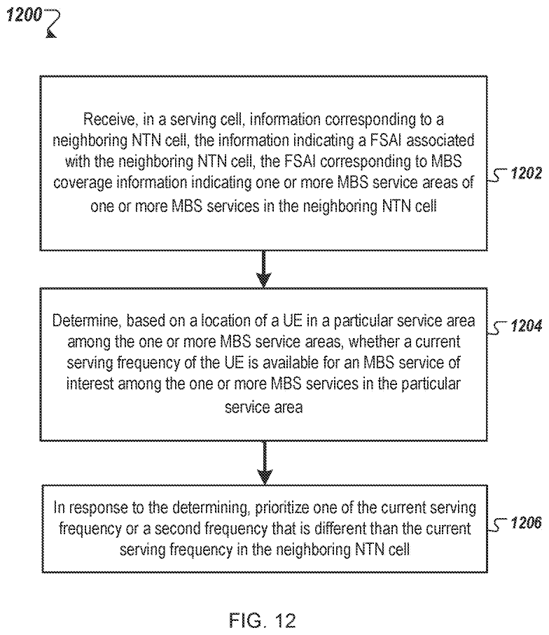

FIG. 12 illustrates an example process of receiving MBS services in an NTN cell, according to some implementations. The process 1200 is described as being performed by a UE, such as UE 110 of FIG. 1 or UE 1300 of FIG. 13. The example process 1200 shown in FIG. 12 can be modified or reconfigured to include additional, fewer, or different steps (not shown in FIG. 12), which can be performed in the order shown or in a different order.

At 1202, the UE receives, in a serving cell, information corresponding to a neighboring NTN cell, the information indicating an FSAI associated with the neighboring NTN cell. The FSAI corresponds to MBS coverage information indicating one or more MBS service areas of one or more MBS services in the neighboring NTN cell.

At 1204, the UE determines, based on a location of a UE in a particular service area among the one or more MBS service areas, whether a current serving frequency of the UE is available for an MBS service of interest among the one or more MBS services in the particular service area.

At 1206, in response to the determination, the UE prioritizes one of the current serving frequency or a second frequency that is different from the current serving frequency in the neighboring NTN cell. If the current serving frequency is available for the MBS service of interest in the particular service area, the UE selects the current serving frequency to receive the MBS service of interest. If the current serving frequency is unavailable for the MBS service of interest in the particular service area, e.g., the MBS service of interest in the particular service area is served by a second frequency, the UE selects the second frequency as a new serving frequency in the neighboring NTN cell.

FIG. 13 is a block diagram of an example UE, according to some implementations. The UE 1300 may be similar to and substantially interchangeable with UE 110 of FIG. 1.

The UE 1300 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smartwatch), relaxed-IoT devices.

The UE 1300 may include processors 1302, RF interface circuitry 1304, memory/storage 1306, user interface 1308, sensors 1310, driver circuitry 1312, power management integrated circuit (PMIC) 1314, antenna structure 1316, and battery 1318. The components of the UE 1300 may be implemented as integrated circuits (ICs), portions thereof, discrete electronic devices, or other modules, logic, hardware, software, firmware, or a combination thereof. The block diagram of FIG. 13 is intended to show a high-level view of some of the components of the UE 1300. However, some of the components shown may be omitted, additional components may be present, and different arrangements of the components shown may occur in other implementations.

The components of the UE 1300 may be coupled with various other components over one or more interconnects 1320, which may represent any type of interface, input/output, bus (local, system, or expansion), transmission line, trace, optical connection, etc. that allows various circuit components (on common or different chips or chipsets) to interact with one another.

The processors 1302 may include processor circuitry such as, for example, baseband processor circuitry (BB) 1322A, central processor unit circuitry (CPU) 1322B, and graphics processor unit circuitry (GPU) 1322C. The processors 1302 may include any type of circuitry or processor circuitry that executes or otherwise operates computer-executable instructions, such as program code, software modules, or functional processes from memory/storage 1306 to cause the UE 1300 to perform operations as described herein.

In some implementations, the baseband processor circuitry 1322A may access a communication protocol stack 1324 in the memory/storage 1306 to communicate over a 3GPP compatible network. In general, the baseband processor circuitry 1322A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1304. The baseband processor circuitry 1322A may generate or process baseband signals or waveforms that carry information in 3GPP-compatible networks. In some implementations, the waveforms for NR may be based on cyclic prefix OFDM “CP-OFDM” in the uplink or downlink, and discrete Fourier transform spread OFDM “DFT-S-OFDM” in the uplink.

The memory/storage 1306 may include one or more non-transitory, computer-readable media that includes instructions (for example, communication protocol stack 1324) that may be executed by one or more of the processors 1302 to cause the UE 1300 to perform various operations described herein. The memory/storage 1306 includes any type of volatile or non-volatile memory that may be distributed throughout the UE 1300. In some implementations, some of the memory/storage 1306 may be located on the processors 1302 themselves (for example, L1 and L2 cache), while other memory/storage 1306 is external to the processors 1302 but accessible thereto via a memory interface. The memory/storage 1306 may include any suitable volatile or non-volatile memory such as, but not limited to, dynamic random-access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1304 may include transceiver circuitry and radio frequency front module (RFEM) that allows the UE 1300 to communicate with other devices over a radio access network. The RF interface circuitry 1304 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1316 and proceed to filter and amplify (with a low-noise amplifier) the signal. The signal may be provided to a receiver of the transceiver that downconverts the RF signal into a baseband signal that is provided to the baseband processor of the processors 1302.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1316.

In various implementations, the RF interface circuitry 1304 may be configured to transmit/receive signals in a manner compatible with NR access technologies.

The antenna 1316 may include antenna elements to convert electrical signals into radio waves to travel through the air and convert received radio waves into electrical signals. The antenna elements may be arranged into one or more antenna panels. The antenna 1316 may have antenna panels that are omnidirectional, directional, or a combination thereof to enable beamforming and multiple input, multiple output communications. The antenna 1316 may include microstrip antennas, printed antennas fabricated on the surface of one or more printed circuit boards, patch antennas, phased array antennas, etc. The antenna 1316 may have one or more panels designed for specific frequency bands including bands in FR1 or FR2.

The user interface 1308 includes various input/output (I/O) devices designed to enable user interaction with the UE 1300. The user interface 1308 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1300.

The sensors 1310 may include devices, modules, or subsystems whose purpose is to detect events or changes in their environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1312 may include software and hardware elements that operate to control particular devices that are embedded in the UE 1300, attached to the UE 1300, or otherwise communicatively coupled with the UE 1300. The driver circuitry 1312 may include individual drivers allowing other components to interact with or control various input/output (I/O) devices that may be present within, or connected to, the UE 1300. For example, driver circuitry 1312 may include a display driver to control and allow access to a display device, a touchscreen driver to control and allow access to a touchscreen interface, sensor drivers to obtain sensor readings of sensors 1310 and control and allow access to sensors 1310, drivers to obtain actuator positions of electro-mechanic components or control and allow access to the electro-mechanic components, a camera driver to control and allow access to an embedded image capture device, audio drivers to control and allow access to one or more audio devices.

The PMIC 1314 may manage power provided to various components of the UE 1300. In particular, with respect to the processors 1302, the PMIC 1314 may control power-source selection, voltage scaling, battery charging, or DC-to-DC conversion.

In some implementations, the PMIC 1314 may control, or otherwise be part of, various power saving mechanisms of the UE 1300 including DRX as discussed herein. A battery 1318 may power the UE 1300, although in some examples the UE 1300 may be mounted or deployed in a fixed location, and may have a power supply coupled to an electrical grid. The battery 1318 may be a lithium-ion battery, a metal-air battery, such as a zinc-air battery, an aluminum-air battery, a lithium-air battery, and the like. In some implementations, such as in vehicle-based applications, the battery 1318 may be a typical lead-acid automotive battery.

FIG. 14 is a block diagram of an example access node, according to some implementations. FIG. 14 illustrates an access node 1400 (e.g., a base station or gNB), in accordance with some implementations. The access node 1400 may be similar to and substantially interchangeable with the base station 108 of FIG. 1. The access node 1400 may include processors 1402, RF interface circuitry 1404, core network (CN) interface circuitry 1406, memory/storage circuitry 1408, and antenna structure 1410.

The components of the access node 1400 may be coupled with various other components over one or more interconnects 1412. The processors 1402, RF interface circuitry 1404, memory/storage circuitry 1408 (including communication protocol stack 1414), antenna structure 1410, and interconnects 1412 may be similar to like-named elements shown and described with respect to FIG. 13. For example, the processors 1402 may include processor circuitry such as, for example, baseband processor circuitry (BB) 1416A, central processor unit circuitry (CPU) 1416B, and graphics processor unit circuitry (GPU) 1416C.

The CN interface circuitry 1406 may provide connectivity to a core network, for example, a 5^{th} Generation Core network (5GC) using a 5GC-compatible network interface protocol such as carrier Ethernet protocols, or some other suitable protocol. Network connectivity may be provided to/from the access node 1400 via a fiber optic or wireless backhaul. The CN interface circuitry 1406 may include one or more dedicated processors or FPGAs to communicate using one or more of the aforementioned protocols. In some implementations, the CN interface circuitry 1406 may include multiple controllers to provide connectivity to other networks using the same or different protocols.

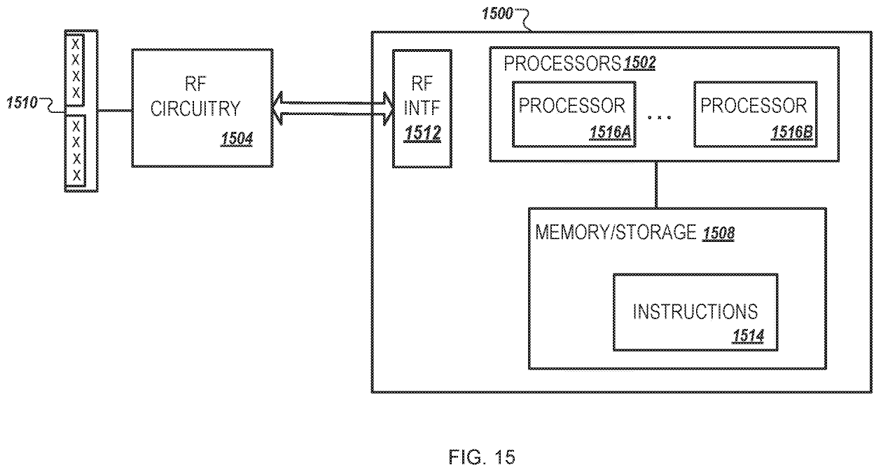

FIG. 15 is a block diagram of an example apparatus 1500, according to some implementations. In some implementations, the apparatus 1500 includes a baseband processor circuitry. For example, the apparatus 1500 may be similar to the baseband processor circuitry (BB) 1322A of FIG. 13 or the baseband processor circuitry (BB) 1416A of FIG. 14 in some cases.

As shown, the apparatus 1500 includes one or more processors 1516A and 1516B, and memory/storage 1508 storing instructions 1514 that are executed by the one or more processors 1516A and 1516B. Although FIG. 15 illustrates the apparatus 1500 as having multiple processors, in some cases the apparatus 1500 can include a single processor (e.g., one of processor 1516A or processor 1516B).

The apparatus 1500 is electrically and communicatively coupled, through RF interface 1512, to RF circuitry 1504 and associated antenna structure 1510. In some implementations, one or more of the processors 1516A and 1516B execute the instructions 1514 to control communications through the RF interface circuitry 1504 and antenna structure 1510. For example, the one or more processors 1516A and 1516B may execute the instructions 1514 to generate or process baseband signals or waveforms that carry information using wireless channels, and/or manage the radio functions of RF circuitry 1504 and antenna structure 1510, such as signal modulation, encoding, radio frequency shifting, in addition or as an alternative to the user plane or control plane functions as described with respect to the baseband processor circuitry (BB) 1322A of FIG. 13 and the baseband processor circuitry (BB) 1416A of FIG. 14. In doing so, the apparatus 1500 enables communication, e.g., wireless cellular communication, over a 3GPP compatible network.

Additionally, in some implementations, the apparatus 1500 may include wireless hardware connectivity interface(s) to send/receive data to/from Near Field Communication (NFC) components, Bluetooth® components (e.g., Bluetooth® Low Energy), Wi-Fi® components, and other communication components, and a power management interface (e.g., an interface to send/receive power). In such implementations, the instructions 1514 may include instructions that, when executed by one or more of the processors 1516A and 1516B, cause these processors to perform Wi-Fi communications on an 802.11 network, and/or perform Bluetooth communications.

In some implementations, one or more of the processors 1516A and 1516B is a 3G baseband processor, a 4G baseband processor, a 5G baseband processor, or other suitable baseband processor. In some implementations, one or more of the processors 1516A and 1516B may be configured as an FPGA (Field Programmable Gate Array), and/or may have dedicated hardware components, which may include an ASIC (Application Specific Integrated Circuit).

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1400 that operates in an NR or 5G system (for example, a gNB), and the term “E-UTRAN node” or the like may refer to an access node 1400 that operates in an LTE or 4G system (e.g., an eNB). According to various implementations, the access node 1400 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1400 may be implemented as one or more software entities running on server computers as part of a virtual network, which may be referred to as a CRAN and/or a virtual baseband unit pool (vBBUP). In these implementations, the CRAN or vBBUP may implement a RAN function split, such as a PDCP split wherein RRC and PDCP layers are operated by the CRAN/vBBUP and other L2 protocol entities are operated by the access node 1400; a MAC/PHY split wherein RRC, PDCP, RLC, and MAC layers are operated by the CRAN/vBBUP and the PHY layer is operated by the access node 1400; or a “lower PHY” split wherein RRC, PDCP, RLC, MAC layers and upper portions of the PHY layer are operated by the CRAN/vBBUP and lower portions of the PHY layer are operated by the access node 1400.

In V2X scenarios, the access node 1400 may be or act as RSUs. The term “RoadSide Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

For one or more implementations, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below.

### EXAMPLES

In the following section, further exemplary implementations are provided.

Example 1 includes a method, including: receiving an information element (IE) including Multicast-Broadcast Services (MBS) service area information indicating one or more MBS service areas in a non-terrestrial network (NTN) serving cell.

Example 2 is the method of Example 1, wherein at least one of the one or more MBS service areas is smaller than a coverage area of the NTN serving cell.

Example 3 is the method of Examples 1 or 2, wherein the MBS service area information includes a Synchronization Signal Block (SSB) list including one or more SSB groups, each SSB group (i) including one or more SSBs, and (ii) is associated with a respective MBS service area among the one or more MBS service areas or a respective transmission beam.

Example 4 is the method of any one of Examples 1-3, wherein the MBS service area information includes an MBS coverage identifier (ID) list including one or more MBS service area coverage IDs, each MBS service area coverage ID is associated with a respective MBS service area among the one or more MBS service areas, wherein each MBS service area includes a reference location specifying a respective MBS service area among the one or more MBS service areas.

Example 5 is the method of Example 4, wherein each MBS service area further includes a distance parameter corresponding to the reference location.

Example 6 is the method of any one of Examples 1-5, wherein the MBS service area information includes at least one of a Public Land Mobile Network (PLMN) list including one or more PLMN identifiers (IDs) or a Tracking Area (TA) list including TA IDs.

Example 7 is the method of Example 6, wherein a PLMN ID in conjunction with a TA ID corresponds to a respective MBS service area among the one or more MBS service areas.

Example 8 is the method of Examples 1-7, wherein the IE is transmitted from a core network entity, and wherein the receiving includes receiving the IE at an access node.

Example 9 is the method of Example 8, wherein the core network entity includes an Access and Mobility Management Function (AMF) and the access node includes a base station.

Example 10 includes a method including: generating a System Information Block (SIB) including a Multicast-Broadcast Services (MBS) coverage area information indicating one or more MBS service areas in a non-terrestrial network (NTN) serving cell, wherein an MBS service area of the one or more MBS service areas is identified by a respective MBS service area coverage identifier (ID); and transmitting the SIB to a user equipment (UE) in a signaling message.

Example 11 is the method of Example 10, wherein at least one of the one or more MBS service areas is smaller than a coverage area of the NTN serving cell.

Example 12 is the method of Example 10 or 11, wherein generating the SIB further includes associating each MBS service area coverage ID with at least one respective MBS session ID.

Example 13 is the method of any one of Examples 10-12, wherein the SIB is a new SIB or an existing SIB.

Example 14 is the method of any one of Examples 10-13, wherein the generating and the transmitting are performed by a base station.

Example 15 includes a method including: generating a Multicast-Broadcast Services (MBS) session information element (IE) indicating (i) an MBS session identifier (ID) of an MBS session and (ii) one or more Synchronization Signal Blocks (SSBs) corresponding to the MBS session ID, wherein the MBS session IE further includes information associating each SSB of the one or more SSBs is associated with a respective transmission beam; and transmitting the MBS session information IE to a user equipment (UE) in a signaling message.

Example 16 is the method of Example 15, wherein the generating and the transmitting are performed by a base station.

Example 17 includes a method including: generating a Multicast-Broadcast Services (MBS) session information element (IE) indicating an MBS session identifier (ID) of an MBS session, wherein the MBS session ID is specified by temporary Mobile Group Identity (TMGI) information, the MBS session IE further including a field indicating presence of an MBS service area within a non-terrestrial network (NTN) serving cell, the MBS service area corresponding to the MBS session identifier (ID); and transmitting the MBS session information IE to a user equipment (UE) in a signaling message.

Example 18 is the method of Example 17, wherein the generating and the transmitting are performed by a base station.

Example 19 includes a method, including: transmitting, using a Multicast Control Channel (MCCH) signal, an information element (IE) including Multicast-Broadcast Services (MBS) coverage information associated with an MBS service area in a non-terrestrial network (NTN) serving cell, the MCCH signal corresponding to the MBS service area.

Example 20 is the method of Example 19, wherein the MBS service area is smaller than a coverage area of the NTN serving cell.

Example 21 includes one or more processors of a base station configured to perform the method of any one of Examples 1-20.

Example 22 includes a base station, including: one or more processors; and one or more memory devices storing instructions that, when executed, cause the one or more processors to perform the method of any one of Examples 1-20.

Example 23 includes a method, including: receiving an information element (IE) including Multicast-Broadcast Services (MBS) service area information indicating one or more MBS service areas in a non-terrestrial network (NTN) serving cell.

Example 24 is the method of Example 23, wherein at least one of the one or more MBS service areas is smaller than a coverage area of the NTN serving cell.

Example 25 is the method of Examples 23 or 24, wherein the MBS service area information includes a Synchronization Signal Block (SSB) list including one or more SSB groups, each SSB group (i) including one or more SSBs, and (ii) is associated with a respective MBS service area among the one or more MBS service areas and a respective transmission beam.

Example 26 is the method of any one of Examples 23-25, wherein the MBS service area information includes an MBS coverage identifier (ID) list including one or more MBS service area coverage IDs, each MBS service area coverage ID being associated with a respective MBS service area among the one or more MBS service areas, wherein each MBS service area includes a reference location specifying a respective MBS service area among the one or more MBS service areas.

Example 27 is the method of Example 26, wherein each MBS service area further includes a distance parameter corresponding to a respective reference location.

Example 28 is the method of Examples 26 or 27, wherein the MBS service area information includes a Public Land Mobile Network (PLMN) list including at least one of one or more PLMN identifiers (IDs) or a Tracking Area (TA) list including TA IDs.

Example 29 is the method of Example 28, wherein a PLMN ID in conjunction with a TA ID corresponds to a respective MBS service area among the one or more MBS service areas.

Example 30 is the method of any one of Examples 23-29, wherein the IE is transmitted from a base station, and wherein the receiving includes receiving the IE at a UE.

Example 31 includes a method including: receiving a System Information Block (SIB) including a Multicast-Broadcast Services (MBS) coverage area information indicating one or more MBS service areas in a non-terrestrial network (NTN) serving cell, wherein an MBS service area is identified by a respective MBS service area coverage identifier (ID).

Example 32 is the method of Example 31, wherein at least one of the one or more MBS service areas is smaller than a coverage area of the NTN serving cell.

Example 33 is the method of Examples 31 or 32, wherein each MBS service area coverage ID is associated with a respective MBS session ID.

Example 34 is the method of any one of Examples 31-33, wherein the SIB is a new SIB or an existing SIB.

Example 35 is the method of any one of Examples 31-34, wherein the receiving includes receiving the SIB at a user equipment (UE).

Example 36 includes a method, including: receiving an MBS session information element (IE) indicating (i) an MBS session identifier (ID) of an MBS session and (ii) one or more Synchronization Signal Blocks (SSBs) corresponding to the MBS session, wherein the MBS session IE further includes information associating each SSB of the one or more SSBs with a respective transmission beam.

Example 37 is the method of Example 36, wherein the receiving includes receiving the MBS session information IE at a UE.

Example 38 includes a method, including: receiving an MBS session information element (IE) an MBS session identifier (ID) of an MBS session, wherein the MBS session ID is specified by temporary Mobile Group Identity (TMGI) information, the MBS session information IE further including a field indicating presence of an MBS service area within a non-terrestrial network (NTN) serving cell, the MBS service area corresponding to the MBS session identifier (ID).

Example 39 is the method of Example 38, wherein the MBS service area is smaller than a coverage area of the NTN serving cell.

Example 40 is the method of Example 38 or 39, wherein the receiving includes receiving the MBS session information IE at a UE.

Example 41 includes a method, including: receiving, using a Multicast Control Channel (MCCH) signal, an information element (IE) including Multicast-Broadcast Services (MBS) coverage information associated with an MBS service area in a non-terrestrial network (NTN) serving cell, the MCCH signal corresponding to the MBS service area.

Example 42 is the method of Example 41, wherein the MBS service area is smaller than a coverage area of the NTN serving cell.

Example 43 is the method of Examples 41 or 42, wherein the receiving includes receiving the IE at a UE.

Example 44 includes a method, including: receiving information corresponding to a non-terrestrial network (NTN) neighboring cell, the information indicating that a Multicast-Broadcast Services (MBS) service is provided in a particular service area of the NTN neighboring cell; and determining, based at least on the information indicating that the MBS service is provided in the particular service area of the NTN neighboring cell, whether to initiate a unicast transmission for the MBS service in the NTN neighboring cell or continue to receive the MBS service in a multicast transmission in the NTN neighboring cell.

Example 45 is the method of Example 44, wherein the particular service area is smaller than a coverage area of the NTN neighboring cell.

Example 46 is the method of Examples 44 or 45, wherein determining whether to initiate the unicast transmission or continue to receive the MBS service in the multicast transmission including: moving to the NTN neighboring cell; determining that a location of a user equipment (UE) is outside of the particular service area in the NTN neighboring cell; and in response to the determining, initiating the unicast transmission.

Example 47 is the method of Example 44, wherein determining whether to initiate the unicast transmission or continue to receive the MBS service in the multicast transmission further includes: moving to the NTN neighboring cell; determining that a location of a user equipment (UE) is within the particular service area in the NTN neighboring cell; and in response to the determining, receiving, in an idle or an inactive state, the MBS service.

Example 48 is the method of Example 44, wherein the receiving and determining are performed by a UE.

Example 49 includes a method, including: receiving information corresponding to a neighboring non-terrestrial network (NTN) cell, the information indicating a Frequency Specific Area Identity (FSAI) associated with the neighboring NTN cell, the FSAI corresponding to Multicast-Broadcast Services (MBS) coverage information indicating one or more MBS service areas of one or more MBS services in the neighboring NTN cell and respective frequencies; determining, based on a location of a user equipment (UE) in a particular service area among the one or more MBS service areas, that a particular frequency corresponding to an MBS service of interest among the one or more MBS services is available in the particular service area, the particular frequency being different from a current serving frequency; and selecting the particular frequency as a new serving frequency in the neighboring NTN cell.

Example 50 is the method of Example 49, wherein the receiving, determining, and selecting are performed by a UE.

Example 51 includes a method, including: receiving information corresponding to a neighboring non-terrestrial network (NTN) cell, the information indicating a Frequency Specific Area Identity (FSAI) associated with the neighboring NTN cell, the FSAI corresponding to Multicast-Broadcast Services (MBS) coverage information indicating one or more MBS service areas of one or more MBS services in the neighboring NTN cell; determining, based on a location of a user equipment (UE) in a particular service area among the one or more MBS service areas, whether a current serving frequency of the UE is available for an MBS service of interest among the one or more MBS services in the particular service area; and in response to the determining, prioritizing one of the current serving frequency or a second frequency that is different than the current serving frequency in the neighboring NTN cell.

Example 52 is the method of Example 51, wherein prioritizing one of the current serving frequency or the second frequency includes: in response to determining that the current serving frequency is available for the MBS service of interest in the particular service area, selecting the current serving frequency to receive the MBS service of interest.

Example 53 is the method of Examples 51 or 52, wherein prioritizing one of the current serving frequency or the second frequency includes: in response to determining that the MBS service of interest in the particular service area is served by the second frequency, selecting the second frequency as a new serving frequency.

Example 54 is the method of any one of Examples 51-53, wherein the receiving, determining, and prioritizing are performed by a UE.

Example 55 includes one or more processors of a user equipment (UE) configured to perform the method of any one of Examples 23-54.

Example 56 includes an apparatus including: one or more processors; and one or more memory devices storing instructions that, when executed, cause the one or more processors to perform the method of any one of Examples 23-54.

Any of the above-described examples may be combined with any other example (or combination of examples), unless explicitly stated otherwise. The foregoing description of one or more implementations provides illustration and description, but is not intended to be exhaustive or to limit the scope of implementations to the precise form disclosed. Modifications and variations are possible in light of the above teachings or may be acquired from practice of various implementations.

Various components may be described as performing a task or tasks, for convenience in the description. Such descriptions should be interpreted as including the phrase “configured to.” Reciting a component that is configured to perform one or more tasks is expressly intended not to invoke 35 USC § 112(f) interpretation for that component.

For one or more implementations, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of implementations to the precise form disclosed. Modifications and variations are possible in light of the above teachings or may be acquired from practice of various implementations.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

We claim:

1. A method, comprising:
receiving an information element (IE) comprising Multicast-Broadcast Services (MBS) service area information indicating one or more MBS service areas in a non-terrestrial network (NTN) serving cell.

2. The method of claim 1, wherein at least one of the one or more MBS service areas is smaller than a coverage area of the NTN serving cell.

3. The method of claim 1, wherein the MBS service area information comprises an MBS coverage identifier (ID) list comprising one or more MBS service area coverage IDs, each MBS service area coverage ID is associated with a respective MBS service area among the one or more MBS service areas, wherein each MBS service area comprises a reference location specifying a respective MBS service area among the one or more MBS service areas.

4. The method of claim 3, wherein each MBS service area further comprises a distance parameter corresponding to the reference location.

5. The method of claim 1, wherein the IE comprising MBS service area information is received at a base station from an Access and Mobility Management Function (AMF).

6. The method of claim 1, wherein the IE comprising MBS service area information is received at a user equipment (UE) from a base station.

7. A method comprising:
generating a System Information Block (SIB) comprising a Multicast-Broadcast Services (MBS) coverage area information indicating one or more MBS service areas in a non-terrestrial network (NTN) serving cell, wherein an MBS service area of the one or more MBS service areas is identified by a respective MBS service area coverage identifier (ID); and
transmitting the SIB to a user equipment (UE) in a signaling message.

8. The method of claim 7, wherein at least one of the one or more MBS service areas is smaller than a coverage area of the NTN serving cell.

9. The method of claim 7, wherein generating the SIB further comprises associating each MBS service area coverage ID with at least one respective MBS session ID.

10. The method of claim 7, wherein the SIB is a new SIB or an existing SIB.

11. The method of claim 7, wherein the generating and the transmitting are performed by a base station.

12. One or more processors of a base station configured to perform the method of claim 1.

13. A base station, comprising:
one or more processors; and
one or more memory devices storing instructions that, when executed, cause the one or more processors to perform the method of claim 7.

14. A method comprising:
receiving a System Information Block (SIB) comprising a Multicast-Broadcast Services (MBS) coverage area information indicating one or more MBS service areas in a non-terrestrial network (NTN) serving cell, wherein an MBS service area is identified by a respective MBS service area coverage identifier (ID).

15. The method of claim 14, wherein at least one of the one or more MBS service areas is smaller than a coverage area of the NTN serving cell.

16. The method of claim 14, wherein each MBS service area coverage ID is associated with a respective MBS session ID.

17. The method of claim 14, wherein the SIB is a new SIB or an existing SIB.

18. The method of claim 14, wherein the receiving comprises receiving the SIB at a user equipment (UE).

19. One or more processors of a user equipment (UE) configured to perform the method of claim 14.

20. An apparatus comprising:
one or more processors; and
one or more memory devices storing instructions that, when executed, cause the one or more processors to perform the method of claim 1.
